(19) United States
(12) Patent Application Publication
(10) Pub. No.: US 2009/0132172 A1
(43) Pub. Date: May 21, 2009

(54) METHODS FOR DETECTING AND DIAGNOSING LOW BONE MASS DENSITY

(75) Inventor: Peng Xiao, Omaha, NE (US)

Correspondence Address: POLSINELLI SHUGART PC, 700 W. 47TH STREET, SUITE 1000, KANSAS CITY, MO, 64112-1802, US

(73) Assignee: CREIGHTON UNIVERSITY, Omaha, NE (US)

(21) Appl. No.: 12/211,133

(22) Filed: Sep. 16, 2008

Related U.S. Application Data
(60) Provisional application No. 61/003,170, filed on Nov. 15, 2007.

(51) Int. Cl. G06F 7/00

(52) U.S. Cl. 702/19

(57) ABSTRACT

The invention encompasses methods of detecting and diagnosing low bone mass density. The method comprises, in part, obtaining nucleic acid expression data from a plurality of nucleic acid sequences, wherein at least one nucleic acid sequence is selected from the group consisting of ESR1, MAPK3, MECP2, PSTPIP1, SLA, STKL1, WNK1, and ZNF446.

### CROSS REFERENCE TO RELATED APPLICATIONS

This application claims the priority of U.S. provisional application No. 61/003,170, filed Nov. 15, 2007, hereby incorporated by reference in its entirety.

### GOVERNMENTAL RIGHTS

This invention was made with government support under R21 AG027110-01A1, RO1 GM 60402, RO1 AG026564, P50AR055081, and KO1 AR02170-01A2 awarded by the National Institutes of Health. The government has certain rights in the invention.

### FIELD OF THE INVENTION

The invention encompasses methods of detecting and diagnosing low bone mass density.

### BACKGROUND OF THE INVENTION

Osteoporosis is characterized by low bone mineral density (BMD) and is a major public health threat. The National Osteoporosis Foundation estimates that 10 million Americans currently have osteoporosis and approximately 34 million more are estimated to have low bone mass, increasing their risk of developing the disease. This major public health issue is only expected to increase in association with worldwide aging of the population.

As with all ailments, early detection of risk of the condition could lead to better prevention and treatment of the disease. Guidelines exist to identify high-risk older women by using bone mass density (BMD) screening. However, identifying osteoporosis risk in younger patients is more complicated. In addition, large and expensive equipment is required for accurately determining the risk of osteoporosis, and may not always be available. For these reasons, patients with osteoporosis are not optimally treated, as their conditions fail to be diagnosed.

Therefore, a need exists in the art for a simple clinical test to predict low bone mass density, allowing healthcare providers to optimize osteoporosis treatment. Such a test would also be effective at diagnosing high-risk patients who should receive further testing, and patients for whom further testing can be avoided.

### SUMMARY OF THE INVENTION

Accordingly, one aspect of the present invention encompasses a method for determining the relative level of risk of low bone mass density in a subject. The method comprises, in part, obtaining nucleic acid expression data from a plurality of nucleic acid sequences derived from a biological sample collected from the subject. At least one nucleic acid sequence is selected from the group consisting of ESR1, MAPK3, MECP2, PSTPIP1, SLA, STK11, WNK1, and ZNF446. The expression data is compared to a standard and therefore, the relative risk of low bone mass density in the subject may be determined.

Another aspect of the present invention encompasses a method for diagnosing low bone mass density in a subject. The method comprises, in part, obtaining nucleic acid expression data from a plurality of nucleic acid sequences derived from a biological sample collected from the subject. At least one nucleic acid sequence is selected from the group consisting of ESR1, MAPK3, MECP2, PSTPIP1, SLA, STK11, WNK1, and ZNF446. The expression data is compared to a standard and therefore, the diagnosis of low bone mass density in the subject may be determined.

Yet another aspect of the invention encompasses a method for determining the relative level of risk for low bone mass density in a human subject. The method comprises, in part, obtaining nucleic acid expression data from a plurality of nucleic acid sequences derived from B-cells collected from the subject. At least one nucleic acid sequence is selected from the group consisting of ESR1, MAPK3, MECP2, PSTPIP1, SLA, STK11, WNK1, and ZNF446. The expression data is compared to a standard and therefore, the relative risk of low bone mass density in the subject may be determined.

Other aspects and iterations of the invention are described more thoroughly below.

### BRIEF DESCRIPTION OF THE FIGURES

FIG. 1 depicts two-dimensional hierarchical dendrograms clustered both by the 29 genes of interest, and the studied individuals. The horizontal axis shows the clustering of subjects within the two bone marrow density (BMD) groups (“L” for low BMD, “H” for high BMD, “B” for B cells, and numbers for subject codes), and the vertical axis represents the clustering of the 29 genes according to their RNA normalized expression intensities.

FIG. 2 depicts a network diagram constructed by Ingenuity Pathway Analysis. Shaded genes are focus genes included in the input 29 differentially expressed genes. Direct interactions appear as solid lines, whereas indirect interactions are represented by dotted lines. The score is a numerical value used to rank how relevant the network is to the total input genes. The score takes into account the number of focus genes in the network and the size of the network to approximate how relevant this network is to the original list of genes.

FIG. 3 depicts a comparison of real-time RT-PCR expression levels of the eight confirmed genes between the low and the high BMD groups. Gene expression levels were given by 2^{-ΔC}_{T} (≢C_{T}=C_{T Target Gene}−C_{T GAPDH}, the C_{T} data used to determine the amounts of Target Gene and GAPDH mRNA). Each column represents the expression level (mean and SD) for each gene in each group. P values of student t-test are listed on the top of bars.

FIG. 4 depicts interactions of the 8 real-time RT-PCR-confirmed differentially expressed genes and their potential effects on osteoblastogenesis and osteoclastogenesis. The dashed circle in B cells represents the ESR1 and MAPK3 centered network. Stimulation and inhibition effects are indicated by arrows and “T” head lines respectively.

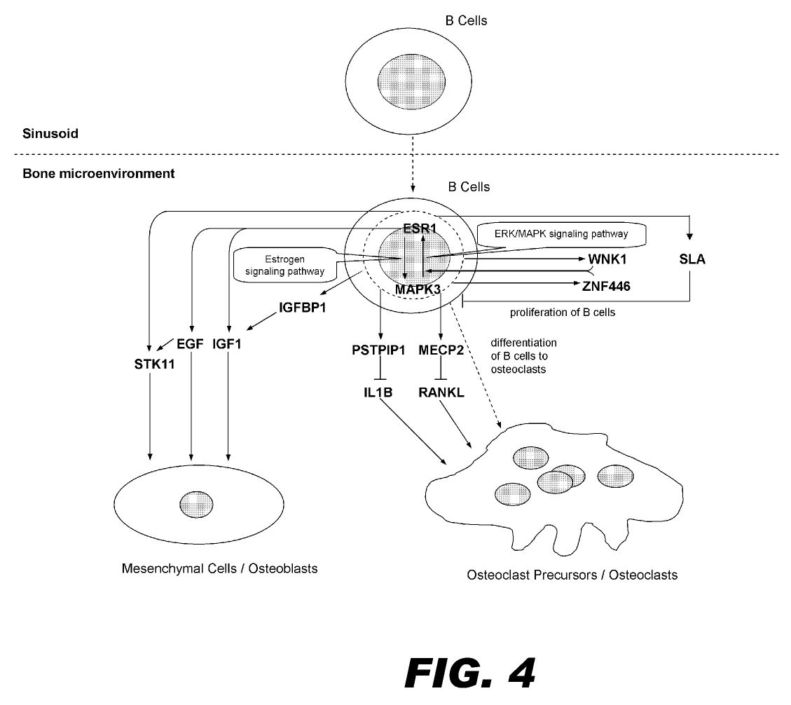

### DETAILED DESCRIPTION OF THE INVENTION

The present invention provides a method for detecting, diagnosing, and determining the relative level of risk of low bone mass density in a subject. As used herein, “low bone mass density” refers to a subject with a T score of less than −1.0. In some embodiments, the low bone mass density causes osteoporosis in the subject. Generally speaking, the method comprises obtaining nucleic acid expression data from a plurality of nucleic acid sequences derived from a biological sample collected from the subject. The nucleic acid expression data may be obtained by measuring the RNA level of the nucleic acid sequences. At least one of the nucleic acid sequences may be ESR1, MAPK3, MECP2, PSTPIP1, SLA, STK11, WNK1, or ZNF446. The nucleic acid expression data may then be compared to a standard, such that low bone mass density may be detected, diagnosed, or the risk for low bone mass density determined.

### (a) Obtaining Nucleic Acid Expression Data

A method of the invention encompasses obtaining nucleic acid expression data from a plurality of nucleic acid sequences. In some embodiments, the nucleic acid sequences may be precursor messenger RNA (pre-mRNA), partially processed mRNA or fully processed mRNA. The differential expression of the plurality of nucleic acid sequences may be measured by a variety of techniques that are well known in the art. Quantifying the levels of the RNA or the levels of the protein product of a mRNA may be used to obtain expression data. In preferred embodiments, expression data is obtained by quantifying RNA levels. Additional information regarding the methods discussed below may be found in Ausubel et al., (2003) Current Protocols in Molecular Biology, John Wiley & Sons, New York, N.Y., or Sambrook et al. (1989) Molecular Cloning: A Laboratory Manual, Cold Spring Harbor Press, Cold Spring Harbor, N.Y. One skilled in the art will know which parameters may be manipulated to optimize detection of the mRNA or protein of interest.

A nucleic acid microarray may be used to quantify the differential expression of a plurality of nucleic acid sequences. Microarray analysis may be performed using commercially available equipment, following manufacturer's protocols, such as by using the Affymetrix GeneChip® technology (Santa Clara, Calif.) or the Microarray System from Incyte (Fremont, Calif.). Typically, single-stranded nucleic acids (e.g., cDNAs or oligonucleotides) are plated, or arrayed, on a microchip substrate. The arrayed sequences are then hybridized with specific nucleic acid probes from the sample. Fluorescently labeled cDNA probes may be generated through incorporation of fluorescently labeled deoxynucleotides by reverse transcription of RNA extracted from the cells of interest. Alternatively, the RNA may be amplified by in vitro transcription and labeled with a marker, such as biotin. The labeled probes are then hybridized to the immobilized nucleic acids on the microchip under highly stringent conditions. After stringent washing to remove the non-specifically bound probes, the chip is scanned by confocal laser microscopy or by another detection method, such as a CCD camera. The raw fluorescence intensity data in the hybridization files are generally preprocessed with the robust multichip average (RMA) algorithm to generate expression values.

Quantitative real-time PCR (QRT-PCR) may also be used to measure the differential expression of a plurality of nucleic acid sequences. In QRT-PCR, the RNA template is generally reverse transcribed into cDNA, which is then amplified via a PCR reaction. The amount of PCR product is followed cycle-by-cycle in real time, which allows for determination of the initial concentrations of mRNA. To measure the amount of PCR product, the reaction may be performed in the presence of a fluorescent dye, such as SYBR Green, which binds to double-stranded DNA. The reaction may also be performed with a fluorescent reporter probe that is specific for the DNA being amplified. A non-limiting example of a fluorescent reporter probe is a TaqMan® probe (Applied Biosystems, Foster City, Calif.). The fluorescent reporter probe fluoresces when the quencher is removed during the PCR extension cycle. Muliplex QRT-PCR may be performed by using multiple gene-specific reporter probes, each of which contains a different fluorophore. Fluorescence values are recorded during each cycle and represent the amount of product amplified to that point in the amplification reaction. To minimize errors and reduce any sample-to-sample variation, QRT-PCR is typically performed using a reference standard. The ideal reference standard is expressed at a constant level among different tissues, and is unaffected by the experimental treatment. Suitable reference standards include, but are not limited to, mRNAs for the housekeeping genes glyceraldehyde-3-phosphate-dehydrogenase (GAPDH) and beta-actin. The level of mRNA in the original sample or the fold change in expression of each biomarker may be determined using calculations well known in the art.

Luminex multiplexing microspheres may also be used to measure the differential expression of a plurality of nucleic acid sequences. These microscopic polystyrene beads are internally color-coded with fluorescent dyes, such that each bead has a unique spectral signature (of which there are up to 100). Beads with the same signature are tagged with a specific oligonucleotide that will bind the target mRNA. The mRNA, in turn, is also tagged with a fluorescent reporter. Hence, there are two sources of color, one from the bead and the other from the reporter molecule on the target. The beads are then incubated with the sample containing the targets, of which up to 100 may be detected in one well. The small size/surface area of the beads and the three dimensional exposure of the beads to the targets allows for nearly solution-phase kinetics during the binding reaction. The captured targets are detected by high-tech fluidics based upon flow cytometry in which lasers excite the internal dyes that identify each bead and also any reporter dye captured during the assay. The data from the acquisition files may be converted into expression values using means known in the art.

In situ hybridization may also be used to measure the differential expression of a plurality of nucleic acid sequences. This method permits the localization of mRNAs of interest in cells in a sample. For this method, the cells may be frozen, or fixed and embedded, and then cut into thin sections, which are arrayed and affixed on a solid surface. The tissue sections are incubated with a labeled antisense probe that will hybridize with an mRNA of interest. The hybridization and washing steps are generally performed under highly stringent conditions. The probe may be labeled with a fluorophore or a small tag (such as biotin or digoxigenin) that may be detected by another protein or antibody, such that the labeled hybrid may be detected and visualized under a microscope. Multiple mRNAs may be detected simultaneously, provided each antisense probe has a distinguishable label. The hybridized sample array is generally scanned under a microscope. Because a sample from a subject may be heterogeneous, the percentage of positively stained cells in the tissue may be determined. This measurement, along with a quantification of the intensity of staining, may be used to generate an expression value for each mRNA.

Northern hybridization may also be used to measure the differential expression of a plurality of nucleic acid sequences. For this method, the nucleic acid sequences extracted from the sample are separated by size using electrophoresis in agarose gels. The separated nucleic acid sequences are then transferred from the gel and permanently attached to a nitrocellulose or nylon membrane. The membrane is then exposed to a hybridization probe; a single-stranded nucleic acid fragment with a specific sequence complementary to the target nucleic acid sequence. The probe nucleic acid is labeled by incorporating radioactivity or tagging the molecule with a fluorescent or chromogenic dye to facilitate detection. After hybridization, excess probe is washed from the membrane, and the pattern of hybridization is visualized on X-ray film by autoradiography in the case of a radioactive or fluorescent probe, or by development of color on the membrane if a chromogenic detection method is used.

### (b) Low Bone Mass Density-Related Nucleic Acid Sequences

As detailed above, a method of the invention encompasses obtaining nucleic acid expression data from a plurality of nucleic acid sequences. In some embodiments, the nucleic acids expression data may be collected for 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35 or more nucleic acid sequences. In some embodiments, the nucleic acid expression data may be for a nucleic acid sequence of MAPK3 encoding the mitogen-activated protein kinase 3, STK11 encoding the serine/threonine kinase 11, MMP23B encoding the matrix metalloproteinase 23B, HAO2 encoding the hydroxyacid oxidase 2 (long chain), PPM1F encoding the protein phosphatase 1F (PP2C domain containing), SETD3 encoding the SET-domain-containing 3, C9ORF127 encoding chromosome 9 open reading frame 127, SLA encoding Src-like-adaptor, C7 encoding complement component 7, SNAI2 encoding snail homolog 2, CREB5 encoding cAMP responsive element binding protein 5, MECP2 encoding methyl CpG binding protein 2, NBR2 encoding neighbor of BRCA1 gene 2, PSTPIP1 encoding proline-serine-threonine phosphatase interacting protein 1, ZNF446 encoding zinc finger protein 446, WNK1 encoding WNK lysine deficient protein kinase 1, MSRB2 encoding methionine sulfoxide reductase B2, GALR1 encoding galanin receptor 1, HCAP-H2 encoding kleisin beta, DARC encoding duffy antigen/chemokine receptor, CES2 encoding carboxylesterase 2, PRX encoding periaxin, PRG3 encoding proteoglycan 3, NEO1 encoding neogenin homolog 1 (chicken), KLK3 encoding kallikrein 3, ESR1 encoding estrogen receptor 1, KCNJ5 encoding potassium inwardly-rectifying channel, subfamily J, member 5, SLC26A3 encoding solute carrier family 26, member 3, or KIAA1446 encoding likely orthologs of rat brain-enriched guanylate kinase-associated protein.

In a preferred embodiment, the nucleic acid expression data may be from a nucleic acid sequence of ESR1, MAPK3, MECP2, PSTPIP1, SLA, STK11, WNK1, and ZNF446. In one embodiment, the nucleic acid expression data may be from at least two nucleic acid sequences selected from the group comprising ESR1, MAPK3, MECP2, PSTPIP1, SLA, STK11, WNK1, and ZNF446. In another embodiment, the nucleic acid expression data may be from at least three, four, five, six, seven, or eight nucleic acid sequences selected from the group comprising ESR1, MAPK3, MECP2, PSTPIP1, SLA, STK11, WNK1, and ZNF446.

(c) Obtaining a Biological Sample from a Subject

The biological sample may be obtained from a human or animal subject. In some embodiments, the subject is at risk for developing low bone mass density. In other embodiments, the subject is at risk for osteoporosis. In a preferred embodiment, the subject may be human. In one embodiment, the subject may be female. In an alternative embodiment, the subject may be male. In another embodiment, the subject may be a post-menopausal female. In yet another embodiment, the subject may be a pre-menopausal female. The terms “post-menopausal” and “pre-menopausal” are meant to be defined by the customary medical usage. In particular, the level of follicle stimulating hormone may be used to determine the advent of menopause. In still another embodiment, the subject may have a T score of less than −1.0.

In some embodiments, the sample may be derived from the digestive system, the skeletal system, the muscular system, the nervous system, the endocrine system, the respiratory system, the circulatory system, the reproductive system, the integumentary system, the lymphatic system, or the urinary system. In preferred embodiments, the sample may be derived from the lymphatic system. In a more preferred embodiment, the sample may be immune cells derived from the lymphatic system. In some embodiments, the immune cells derived from the lymphatic system may be neutrophils, eosinophils, basophils, lymphocytes, monocytes, macrophages, or progenitor cells that produce these cells. In preferred embodiments, the immune cells derived from the lymphatic system may be lymphocytes, such as T cells, B cells or natural killer (NK) cells or progenitor cells that produce lymphocytes. In a preferred embodiment, lymphocytes may be B cells, or progenitor cells that produce B cells. Non-limiting examples of progenitor cells that produce B cells may include progenitor B cells, early pro-B cells, late pro-B cells, large pre-B cells, small pre-B cells, and immature B cells. In a preferred embodiment, B cells may be mature B cells. Mature B cells may be unactivated or activated B cells. In a preferred embodiment, the B cells of the sample may be unactivated B cells. In some embodiments, the sample may be unactivated B cells derived from any suitable tissue, including bone marrow, spleen, lymphatic system or blood. In a preferred embodiment, the sample may be circulating B cells derived from blood. Methods of collecting suitable samples from a subject are well known in the art. For more details, see the Examples.

Methods for purification or enrichment of certain cell types from a sample are well known in the art and are discussed in Ausubel et al., (2003) Current Protocols in Molecular Biology, John Wiley & Sons, New York, N.Y., or Sambrook et al. (1989) Molecular Cloning: A Laboratory Manual, Cold Spring Harbor Press, Cold Spring Harbor, N.Y. One skilled in the art will know which parameters may be manipulated to optimize purification or enrichment of cells of interest. Most commonly, cells are purified or enriched using immunoaffinity to antigens expressed on the surface of the cells. In short, the sample, consisting of a mixture of cells to be separated is incubated with a solid support, usually superparamagnetic beads that facilitate later steps. The solid support is coated with antibodies against a particular surface antigen, causes the cells expressing this antigen to attach to the solid support. If the solid support is superparamagnetic beads, the cells attached to the beads (expressing the antigen) can be separated from the sample by attraction to a strong magnetic field. The procedure may be used for positively selecting the cells expressing the antigen(s) of interest. In negative selection the antibody used is against surface antigen(s), which are known to be present on cells that are not of interest, therefore enriching the sample with the cells of interest.

Methods of obtaining RNA from biological samples derived from a subject are well known in the art. For more details, see the Examples.

### (d) Comparing the Nucleic Acid Expression Data to a Standard

The invention encompasses comparing the nucleic acid expression data derived from a subject (on low bone mass density-related nucleic acids) to a standard to detect, diagnosis, or determine the relative risk of low bone mass density in a subject.

Generally speaking, the standard may comprise nucleic acid expression data for the same low bone mass density-related nucleic acid sequences as used to detect, diagnosis, or determine the relative risk of low bone mass density in a subject. The standard, however, is determined using nucleic acid expression data from subjects with high bone mass density. As used herein, “high bone mass density” refers to a subject with a T score of greater than −1.0. Hence, if there is a statistical difference between the expression data from a test subject, and the standard, the test subject is at risk for low bone mass density. In an alternative embodiment, if there is a statistical difference between the expression data from a test subject, and the standard, the test subject may be diagnosed with low bone mass density.

Methods of comparing the expression data to the standard are known in the art.

### EXAMPLES

The following examples are included to demonstrate preferred embodiments of the invention. It should be appreciated by those of skill in the art that the techniques disclosed in the examples that follow represent techniques discovered by the inventors to function well in the practice of the invention. Those of skill in the art should, however, in light of the present disclosure, appreciate that many changes can be made in the specific embodiments that are disclosed and still obtain a like or similar result without departing from the spirit and scope of the invention, therefore all matter set forth or shown in the accompanying drawings is to be interpreted as illustrative and not in a limiting sense.

### Example 1

### Study Subjects and Bone Mass Density

Microarray technology was applied to B cells freshly isolated from postmenopausal females with low or high bone mass density (BMD) to identify differentially expressed genes that illuminate the functions of B cells in bone metabolism and low bone mass density. This example describes the subjects used in this study, the exclusion criteria used to minimize potential effects of any known non-genetic factors on the outcome of the study, and BMD measurements.

a. Subjects

The study was approved by the Institutional Review Board and all the subjects signed informed-consent documents before entering the project. All the study subjects were Caucasians of European origin recruited from the vicinity of Creighton University in Omaha, Nebr.

Twenty unrelated postmenopausal Caucasian females were recruited, including 10 with low and 10 with high bone mass density (BMD). Their age ranged from 54 to 60. The inclusion criteria are spine or hip Z-score <−0.84 for the low BMD group (bottom 20% of the age-, sex- and ethnicity-matched population) and spine or hip Z-score>0.84 for the high BMD group (top 20% of the age-, sex- and ethnicity-matched population). Postmenopause is defined as the date of the last menses followed by at least 12 months of no menses. Detailed characteristics of the study subjects are given in Table 1.

Seventy-milliliters of blood were drawn from each recruited female. Information such as age, ethnicity, menstrual status, medication history, and disease history was obtained via questionnaire.

TABLE 1
Characteristics of the study subjects.

| | | | | | | | | | | |
|---|---|---|---|---|---|---|---|---|---|---|
| | | | | | | | | | Hard | |
| | | | | | | | Milk | Yogurt | Cheese | |
| | Spine | Hip | BMI§ | | | | (Ounce/ | (Ounce/ | (Ounce/ | |
| Group | Z-score | Z-score | (kg/m²) | Age | YOM* | TOM† | day) | day) | day) | Supplements‡ |

Low BMD

| | | | | | | | | | | |
|---|---|---|---|---|---|---|---|---|---|---|
| L25 | −0.90 | −0.37 | 33.68 | 58 | 10 | Natural | 3 | 0 | 0 | |
| L31 | −1.62 | −0.85 | 24.09 | 56 | 5 | Natural | 3 | 3 | 1 | |
| L37 | −1.30 | −0.76 | 24.52 | 58 | 25 | Surgical | 0 | 0 | 0 | Calcium and |
| | | | | | | | | | | VitD |
| | | | | | | | | | | (600 mg/day, |
| | | | | | | | | | | since 1990) |
| L38 | 0.16 | −0.90 | 24.53 | 59 | 8 | Natural | 0 | 5 | 0.6 | Calcium and |
| | | | | | | | | | | VitD |
| | | | | | | | | | | (600 mg/day, |
| | | | | | | | | | | since 2002) |
| L40 | −0.70 | −0.87 | 22.51 | 58 | 5 | Natural | 16 | 6 | 0.8 | |
| L43 | −0.20 | −0.88 | 40.69 | 60 | 15 | Natural | 0 | 1 | 1 | |
| L48 | −0.52 | −0.89 | 27.35 | 59 | 12 | Natural | 7 | 7 | 0.4 | |
| L50 | 0.30 | −0.91 | 32.01 | 56 | 19 | Surgical | 0 | 0 | 1.5 | |
| L51 | −2.26 | −1.51 | 16.82 | 59 | 9 | Natural | 0 | 6 | 0 | Calcium and |
| | | | | | | | | | | VitD |
| | | | | | | | | | | (500 mg/2days, |
| | | | | | | | | | | since 2005) |
| L52 | −0.73 | −0.85 | 23.66 | 56 | 4 | Natural | 4 | 6 | 0.2 | |
| Mean | −0.78 | −0.88 | 26.99 | 57.9 | | | | | | |
| (SD) | (0.79) | (0.27) | (6.77) | (1.5) | | | | | | |

High BMD

| | | | | | | | | | |
|---|---|---|---|---|---|---|---|---|---|
| H01 | 2.28 | 1.46 | 31.25 | 57 | 16 | Surgical | 2 | 7 | 0 |
| H03 | 2.37 | 0.97 | 29.99 | 57 | 10 | Surgical | 6 | 2 | 1 |
| H10 | 1.66 | 1.29 | 25.81 | 57 | 3 | Natural | 0 | 0 | 0.4 |
| H11 | 1.91 | 2.41 | 22.15 | 60 | 5 | Natural | 8 | 0 | 0.2 |
| H13 | 1.23 | 0.80 | 32.51 | 58 | 19 | Surgical | 0 | 2 | 2 |
| H18 | 2.09 | 3.07 | 35.31 | 54 | 21 | Surgical | 6 | 1 | 0.6 |
| H23 | 2.25 | 2.56 | 26.82 | 54 | 1 | Natural | 3 | 8 | 0.3 |
| H26 | 1.84 | 0.57 | 24.81 | 58 | 6 | Surgical | 0 | 4 | 2 |
| H34 | 2.74 | 1.19 | 30.08 | 55 | 10 | Natural | 7 | 0.1 | 0.2 |
| H80 | 1.94 | 1.93 | 24.27 | 58 | 7 | Natural | 0 | 0.8 | 0 |
| Mean | 2.03 | 1.63 | 28.30 | 56.8 | | | | | |
| (SD) | (0.42) | (0.83) | (4.17) | (1.9) | | | | | |

§Body Mass Index;
*Years Of Menopause;
†Type Of Menopause;
‡No specific medications were taken by the recruited subjects before and during the recruitment.

b. Exclusion Criteria

Exclusion criteria were used to minimize potential effects of any known non-genetic factors on bone metabolism and BMD determination.

Criteria to exclude non-genetic factors that may cause BMD variation included 1) Serious residuals from cerebral vascular disease; 2) Diabetes mellitus, except for easily controlled, non-insulin dependent diabetes mellitus; 3) Chronic renal disease manifest by serum creatinine >1.9 mg/dL; 4) Chronic liver diseases or alcoholism; 5) Significant chronic lung disease; 6) Corticosteroid therapy at pharmacologic levels currently or for more than 6 months duration at any time. 7) Treatment with anticonvulsant therapy currently or for more than 6 months duration at any time; 8) Evidence of other metabolic or inherited bone disease such as hyper- or hypoparathyroidism, Paget's disease, osteomalacia, osteognesis imperfecta, or others; 9) Rheumatoid arthritis or collagen disease; 10) Recent major gastrointestinal disease (within the past year) such as peptic ulcer, malabsorption, chronic ulcerative colitis, regional enteritis or any significant chronic diarrhea state; 11) Significant disease of any endocrine organ that would affect bone mass; 12) Hyperthyroidism; 13) Any neurological or musculoskeletal condition that would be a nongenetic cause of low bone mass; 14) Any other disease, treatment (including bisphosphonates), or condition (such as hormone replacement therapy) that would be an apparent nongenetic factor underlying of BMD.

Additional criteria to exclude diseases/conditions, which may lead to gene expression changes of B-lymphocytes may be used. Subjects with a diagnosis of idiopathic low bone mass density, or those on calcium and/or vitamin D supplements were not excluded.

Given that B-lymphocytes are also an essential component of the immune system, the following additional exclusion criteria were adopted in order to minimize the effect of diseases or conditions, which may potentially lead to the protein expression changes: Autoimmune or autoimmune-related diseases such as systemic lupus erythematosus, rheumatoid arthritis, multiple sclerosis, Graves disease, Hashimoto's thyroiditis, myasthenia gravis, Addison's disease, dermatomyositis, Sjogren's syndrome, and Reiter's syndrome; immune-deficiency conditions such as: AIDS, severe malnutrition, spleenectomy, other conditions that may result in an immune-deficiency state such as ataxia-telangiectasia, DiGeorge syndrome, Chediak-Higashi syndrome, job syndrome, leukocyte adhesion defects, panhypogammaglobulinemia, selective deficiency of IgA, combined immunodeficiency disease, Wiscott-Aldrich syndrome and complement deficiencies; Haemopoietic and lymphoreticular malignancies such as: leukaemias, lymphomas (Hodgkin's disease, non-Hodgkin's disease), myeloma, Waldenstrom's macroglobulinaemia, heavy chain disease and others such as leukaemic reticuloendotheliosis, mastocytosis, malignant histiocytosis); and other diseases such as: viral infection (influenza), allergy (active periods of asthma) and chronic obstructive pulmonary disease (COPD).

c. BMD Measurement

BMD (g/cm²) for the lumbar spine (L1-4) and total hip (femoral neck, trochanter, and intertrochanteric region) were measured by Hologic 4500A dual energy X-ray absorptiometry (DXA) scanners (Hologic Inc., Bedford, Mass., USA). The machine was calibrated daily. The measurement precision as reflected by the coefficient of variation (CV) was 0.9% and 1.4% for spine and hip BMD respectively.

### Example 2

### Differential Expression Analyses

Global gene expression analysis with gene arrays was used to identify genes differentially expressed in B cells of low and high BMD subjects described in Example 1 above.

a. B Cell Isolation

B cell isolation from 70 ml whole blood was performed using a positive isolation method with Dynabeads® CD19 (Pan B) and DETACHaBEAD® CD19 (Dynal Biotech, Lake Success, N.Y., USA) following the manufacture's protocols. B cell purity was assessed by flow cytometry (BD Biosciences, San Jose, Calif. USA) with fluorescence labeled antibodies, PE-CD19 and FITC-CD45. The average purity was 96.3% with less than 1% deviation.

b. Total RNA Extraction

Total RNA from B cells was extracted using Qiagen RNeasy Mini Kit (Qiagen, Inc., Valencia, Calif., USA). Total RNA concentration and integrity were determined by an Agilent 2100 Bioanalyzer (Agilent, Palo Alto, Calif., USA). Each RNA sample has an excellent integrity number >9.0 in this study, indicating that RNA degradation due to processing was minimal and negligible.

c. Preparation of cRNA and Gene Chip Hybridization

For each sample, 4 μg total RNA was used for the production of cRNA. The production of cRNA, hybridization, and scanning of HG-133A GeneChip® were performed according to the manufacturer's protocol (Affymetrix, Santa Clara, Calif., USA).

d. Differential Expression Analysis

Microarray Suite 5.0 (MAS 5.0, Affymetrix) software was used to generate array raw data in CEL files. The CEL files were imported into the R software package (http://www.r-project.org), and then the probe level data in CEL files were converted into expression measures and normalized by Robust Multiarray Algorithm (RMA, http://www.bioconductor.org) using the Affy package from Bioconductor (http://www.biconductor.org/) in R environment.

The RMA-transformed data were analyzed by Bioconductor's Multtest package to identify genes differentially expressed between the low and the high BMD groups. In this package, the differential expression was tested by t-statistics. The Benjamini and Hochberg (BH) procedure was used for multiple-testing adjustment and adjusted p value≦0.05 was used as the significant criterion.

e. Results

On average, 36.78%±2.03% of the total of 22,283 probe sets in the array were called “present” based on the analysis with the MAS 5.0 software. Twenty nine genes differentially expressed between the low and high BMD groups were identified after BH adjustment (Table 2). Interestingly, all 29 genes were downregulated in the low BMD group. The raw data was submitted to the NCBI Gene Expression Omnibus data repository with the accession number GSE7429.

TABLE 2
Genes differentially expressed between the high and low BMD groups.

| Gene | | | Genomic | Fold | Raw | Adjusted |
|---|---|---|---|---|---|---|
| Symbol | Gene Full Name | AffyID | Location | L/H* | P value | P value§ |
| MAPK3 | Mitogen-activated protein | 212046_x_at | 16p11 | 0.86 | 5.19E−0.8 | 0.000578 |
| | kinase 3 | | | | | |
| STK11 | Serine/threonine kinase | 204292_x_at | 19p13 | 0.66 | 8.54E−0.8 | 0.000634 |
| | 11 | | | | | |
| MMP23B | Matrix metalloproteinase | 207118_s_at | 1p36 | 0.61 | 2.23E−0.7 | 0.001240 |
| | 23B | | | | | |
| HAO2 | Hydroxyacid oxidase 2 | 220801_s_at | 1p13 | 0.57 | 5.80E−0.7 | 0.002585 |
| | (long chain) | | | | | |
| PPM1F | Protein phosphatase 1F | 207758_at | 22q11 | 0.91 | 1.32E−0.6 | 0.004400 |
| | (PP2C domain | | | | | |
| | containing) | | | | | |
| SETD3 | SET domain containing 3 | 212465_at | 14q32 | 0.81 | 3.10E−0.6 | 0.008634 |
| C9ORF127 | Chromosome 9 open | 207839_s_at | 9p13 | 0.77 | 3.79E−0.6 | 0.009395 |
| | reading frame 127 | | | | | |
| SLA | Src-like-adaptor | 214977_at | 8q24 | 0.48 | 7.48E−0.6 | 0.016677 |
| C7 | Complement component 7 | 202992_at | 5p13 | 0.96 | 8.47E−0.6 | 0.016746 |
| SNAI2 | Snail homolog 2 | 213139_at | 8q11 | 0.97 | 9.02E−0.6 | 0.016746 |
| CREB5 | cAMP responsive element | 205931_s_at | 7p15 | 0.32 | 1.11E−0.5 | 0.019085 |
| | binding protein 5 | | | | | |
| MECP2 | Methyl CpG binding | 202617_s_at | Xq28 | 0.62 | 1.53E−0.5 | 0.020170 |
| | protein 2 | | | | | |
| NBR2 | Neighbor of BRCA1 gene 2 | 207631_at | 17q21 | 0.77 | 1.50E−0.5 | 0.020170 |
| PSTPIP1 | Proline-serine-threonine | 211178_s_at | 15q24-q25 | 0.77 | 1.52E−0.5 | 0.020170 |
| | phosphatase interacting | | | | | |
| | protein 1 | | | | | |
| ZNF446 | Zinc finger protein 446 | 219900_s_at | 19q13 | 0.77 | 1.54E−0.5 | 0.020170 |
| WNK1 | WNK lysine deficient | 202940_at | 12p13 | 0.94 | 2.79E−0.5 | 0.031133 |
| | protein kinase 1 | | | | | |
| MSRB2 | Methionine sulfoxide | 219451_at | 10p12 | 0.64 | 2.72E−0.5 | 0.031133 |
| | reductase B2 | | | | | |
| GALR1 | Galanin receptor 1 | 220821_at | 18q23 | 0.69 | 2.68E−0.5 | 0.031133 |
| HCAP-H2 | Kleisin beta | 205086_s_at | 22q13 | 0.74 | 3.50E−0.5 | 0.033890 |
| DARC | Duffy antigen/chemokine | 208335_s_at | 1q21-q22 | 0.56 | 3.70E−0.5 | 0.033890 |
| | receptor | | | | | |
| CES2 | Carboxylesterase 2 | 213509_x_at | 16q22 | 0.81 | 3.21E−0.5 | 0.033890 |
| PRX | Periaxin | 220024_s_at | 19q13 | 0.84 | 3.71E−0.5 | 0.033890 |
| PRG3 | Proteoglycan 3 | 220811_at | 11q12 | 0.61 | 3.95E−0.5 | 0.033890 |
| NEO1 | Neogenin homolog 1 | 204321_at | 15q22-15q23 | 0.58 | 4.87E−0.5 | 0.040215 |
| | (chicken) | | | | | |
| KLK3 | Kallikrein 3 | 204583_x_at | 19q13 | 0.60 | 5.82E−0.5 | 0.045586 |
| ESR1 | Estrogen receptor 1 | 211233_x_at | 6q25 | 0.87 | 5.93E−0.5 | 0.045586 |
| KCNJ5 | Potassium inwardly- | 208404_x_at | 11q24 | 0.76 | 6.49E−0.8 | 0.048171 |
| | rectifying channel, | | | | | |
| | subfamily J, member 5 | | | | | |
| SLC26A3 | Solute carrier family 26, | 215657_at | 7q31 | 0.41 | 6.74E−0.5 | 0.048420 |
| | member 3 | | | | | |
| KIAA1446 | Likely orthologs of rat | 220795_s_at | 14q32 | 0.67 | 7.08E−0.5 | 0.049286 |
| | brain-enriched guanylate | | | | | |
| | kinase-associated protein | | | | | |

*The ratio of the mean expression value given by MAS 5.0 in the low to that in the high BMD group.
§The BH adjusted P value.

### Example 3

### Clustering and Gene Ontology (GO) Analysis

The differentially expressed genes were clustered and functionally grouped to identify potential trends in significance of B cells in low bone mass density.

a. Data Analysis

The 29 differentially expressed genes identified in Example 2 were further clustered hierarchically in two dimensions at both the gene and sample levels using Cluster software (version 2.50). To gain an overall picture of potential functions of the differentially expressed genes, the genes were classified according to three organizing principles (biological process, molecular function and cellular component) of the GO database (http://www.genontology.org/) by Onto-Express analysis.

b. Results

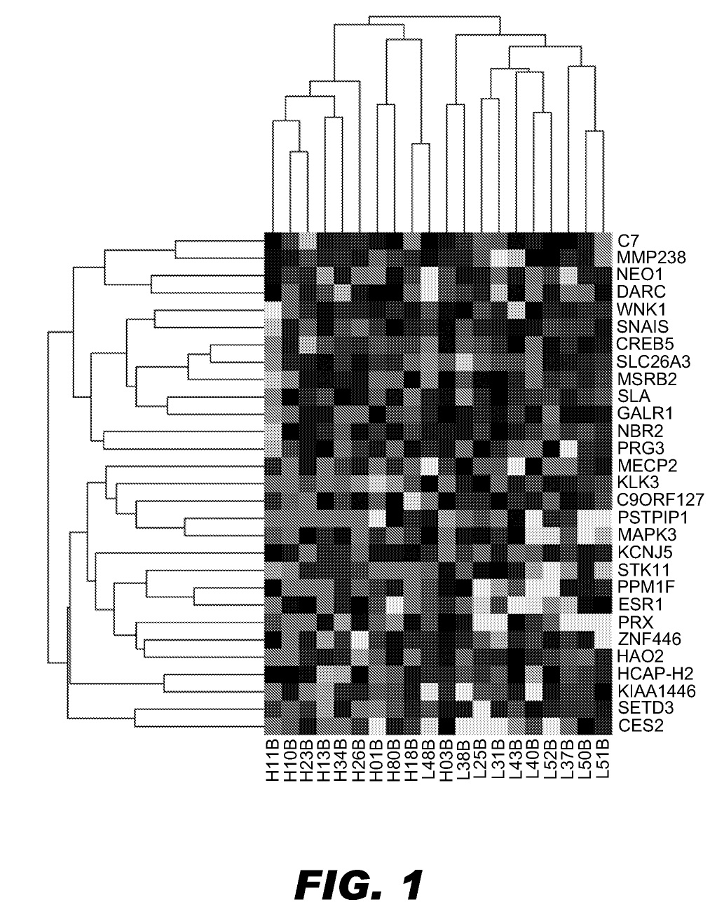

The results of the two-dimensional clustering analyses of the 29 differentially expressed genes are graphically depicted in FIG. 1. As shown in the figure, low and high BMD subjects can be largely separated into two clusters.

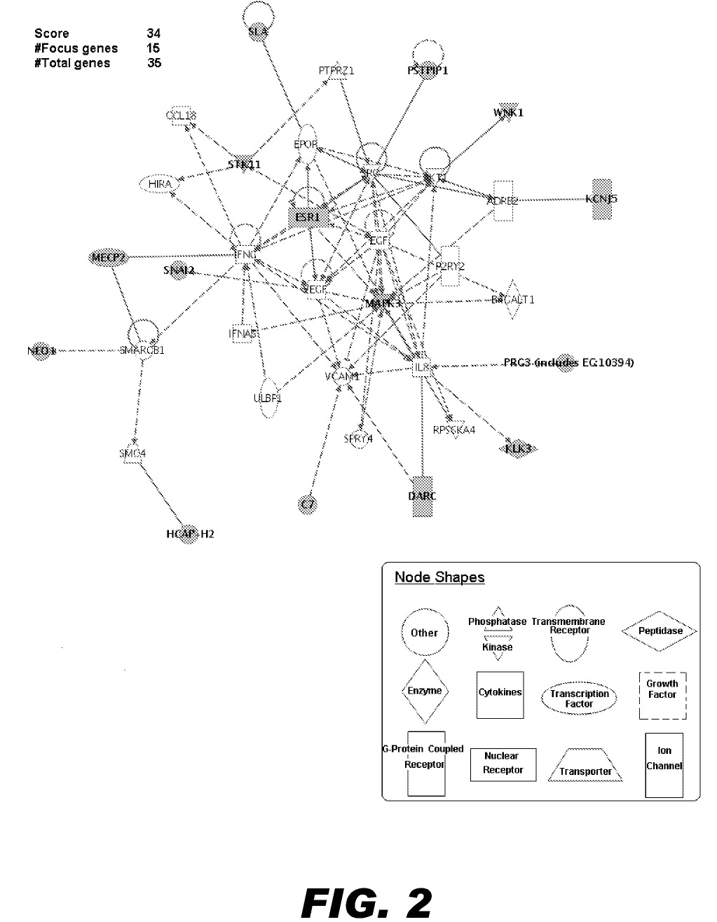

The genes were also classified using GO analyses (FIG. 2). In the “Biological Process” principle, functions of the 29 genes are focused on DNA-dependent regulation of transcription, amino acid phosphorylation, transcription, and signal transduction. In the “Molecular Function” principle, the functions are mainly on protein binding, zinc ion binding, metal ion binding, ATP binding, and transcription factor activity. In the “Cellular Component” principle, the products of those genes are primarily located on membrane and nucleus.

### Example 4

### Network and Pathway Analyses

Canonical pathway analysis was used to identify the pathways that were most significant to the 29 differentially expressed genes identified in Example 2.

a. Data Analysis

The 29 differentially expressed genes identified in Example 2 were further analyzed using Ingenuity Pathways Analysis (IPA) (Ingenuity® System, www.ingenuity. com). A data set containing Affymetrix probe set identifiers and corresponding BH adjusted p values was uploaded into the application. Each identifier was mapped to its corresponding gene object in the Ingenuity Pathways Knowledge Base. These genes, called focus genes, were overlaid onto a global molecular network developed from information contained in the Ingenuity Pathways Knowledge Base. Networks of these focus genes were then algorithmically generated based on their connectivity. Using this system, pathways form the IPA library of canonical pathways were identified using Canonical Pathway Analysis. The significance of the association between the data set and the canonical pathway was measured in two ways: 1) a ratio of the number of genes from the data set that map to the pathway divided by the total number of genes that map to the canonical pathway is displayed; 2) Fisher's exact test was used to calculate a p-value determining the probability that the association between the genes in the dataset and the canonical pathway is explained by chance alone.

b. Results

Using IPA to further analyze the RNA expression data, a significant network involving estrogen receptor 1 (ESR1) and mitogen-activated protein kinase 3 (MAPK3) genes was constructed (FIG. 2). This network includes 35 genes, 15 of which are focus genes. Further Canonical Pathway Analysis performed on the 15 focus genes identified 25 relevant canonical pathways. Names of the canonical pathways and the involved genes in each pathway are summarized in Table 3. It is noticeable that MAPK3 and ESR1 genes are involved in 24 and 2 pathways respectively. Both ESR1 and MAPK3 are included in estrogen receptor signaling and ERK (extracellular signal-regulated kinase)/MAPK signaling pathways.

TABLE 3
Summary of canonical pathway and involved genes

| | Involved | P |
|---|---|---|
| Canonical Pathway | Genes | Value |
| Apoptosis signaling | MAPK3 | 0.001 |
| B Cell Receptor Signaling | MAPK3 | 0.001 |
| Calcium Signaling | MAPK3 | 0.001 |
| cAMP-mediated Signaling | MAPK3 | 0.001 |
| Chemokine Signaling | MAPK3 | 0.001 |
| EGF Signaling | MAPK3 | 0.001 |
| ERK/MAPK Signaling | ESR1 | 0.046 |
| | MAPK3 | 0.001 |
| Estrogen Receptor Signaling | SER1 | 0.046 |
| | MAPK3 | 0.001 |
| Fc Epsilon RI Signaling | MAPK3 | 0.001 |
| FGF Signaling | MAPK3 | 0.001 |
| G-Protein Coupled Receptor Signaling | MAPK3 | 0.001 |
| Glyoxylate and Dicarboxylate Metabolism | HAO2 | 0.003 |
| GM-CSF Signaling | MAPK3 | 0.001 |
| IGF-1 Signaling | MAPK3 | 0.001 |
| IL-10 Signaling | MAPK3 | 0.001 |
| IL-2 Signaling | MAPK3 | 0.001 |
| Integrin Signaling | MAPK3 | 0.001 |
| JAK/Stat Signaling | MAPK3 | 0.001 |
| PDGF Signaling | MAPK3 | 0.001 |
| PI3K/AKT Signaling | MAPK3 | 0.001 |
| PPAR Signaling | MAPK3 | 0.001 |
| PTEN Signaling | MAPK3 | 0.001 |
| T cell Receptor Signaling | MAPK3 | 0.001 |
| TGF-β Signaling | MAPK3 | 0.001 |
| VEGF Signaling | MAPK3 | 0.001 |

P value from Fisher's exact test determines the probability that the association between the gene involved and the canonical pathway is explained by chance alone.

### Example 5

### Real-Time RT-PCR Analyses

Potentially biologically interesting genes were selected for confirmation of gene chip data using real time RT-PCR.

a. Real-Time RT-PCR

Two-step Real-time RT-PCR was used to verify the differentially expressed genes identified from the analyses of chip experiments. The first step is reverse transcription (RT) for synthesis of cDNA from total RNA and the second step is real-time quantitative PCR.

The RT reaction was performed in a 100 μl reaction volume, containing 10 μl 10× Taqman RT Buffer, 22 μl 25 mM MgCl₂, 20 μl dNTPs, 5 μl 50 μM Random Hexamers, 2 μl RNase Inhibitor, 2.5 μl MultiScribe Reverse Transcriptase, 1 μg total RNA, and water to 100 μl. All the RT reagents were supplied by Taqman® Reverse Transcription Reagents (Applied Biosystems, Forest City, Calif., USA). Reaction conditions were as follows, 10 min at 25° C., 30 min at 48° C., 5 min at 95° C.

Multiplex real-time quantitative PCR was performed in 25 μl reaction volume using standard protocols on an Applied Biosystems 7900HT Fast Real-time PCR System.

b. Data Analysis

The cycle number at which the reaction crossed a predetermined cycle threshold (CT) was identified for each gene, and the expression of each target gene relative to GAPDH gene was determined using the equation 2^{-ΔCT}, ΔCT+(CT_{TargetGene}−CT_{GAPDH}). Based on the relative gene expression, we performed student t-test to validate the differentially expressed genes between the two discordant BMD groups.

c. Results

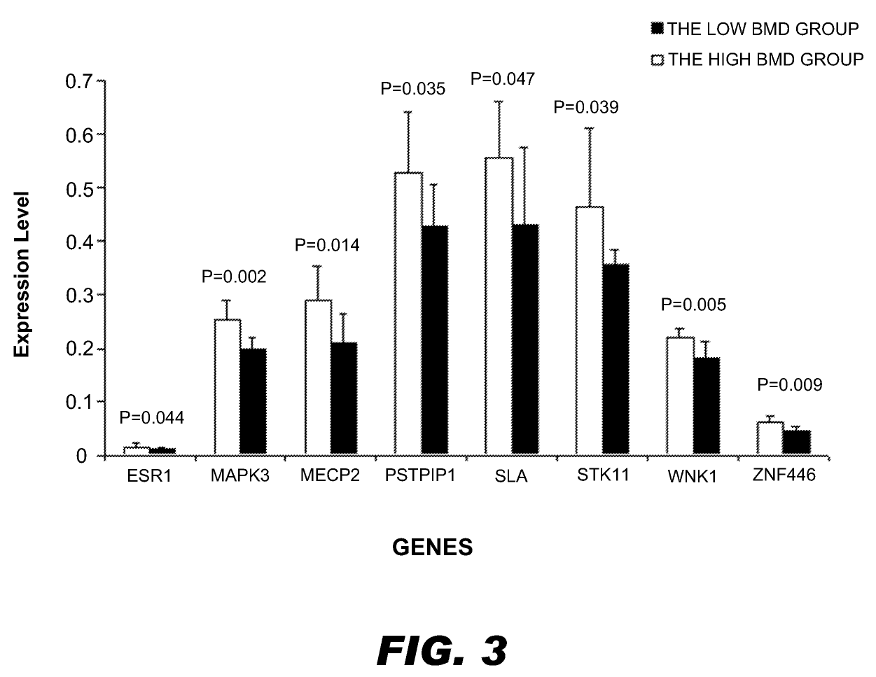

The selection of genes for real-time RT-CR is based on criteria of Assay availability and potential biological interests. From the 29 differentially expressed genes, we selected 14 genes for real-time RT-PPCR, which are C7 (complement component 7), CREB5 (cAMP responsive element binding protein 5), DARC (Duffy antigen/chemokine receptor), ESR1 (estrogen receptor 1), KLK3 (kallikrein 3), MAPK3 (mitogen-activated protein kinase 3), MECP2 (methyl CpG binding protein 2), PRG3 (proteoglycan 3), PST1P1 (proline-serine-threonine phosphtase interacting protein 1), SLA (Src-like-adaptor), SLC26A3 (solute carrier family 26, member 3), STK11 (serine/threonine kinase 11), WNK1 (WNK lysine deficient protein kinase 1), and ZNF446 (zinc finger protein 446). The results confirm downregulation of 8 genes including ESR1, MAPK3, MECP2, PPST1P1, SLA, STK11, WNK1, and ZNF446 in the low BMD group (FIG. 3). Remarkably, except for ZNF446, all 7 other differentially expressed genes verified by real-time RT-PCR are included in the ESR1 and MPK3 centered gene network (FIG. 2).

What is claimed is:

1. A method for determining the relative level of risk of low bone mass density in a subject, the method comprising:
a. obtaining nucleic acid expression data from a plurality of nucleic acid sequences derived from a biological sample collected from the subject, wherein at least one nucleic acid sequence is selected from the group consisting of ESR1, MAPK3, MECP2, PSTPIP1, SLA, STK11, WNK1, and ZNF446;
b. comparing the nucleic acid expression data to a standard to determine the relative risk of low bone mass density in subject.

2. The method of claim 1, wherein the sample comprises blood.

3. The method of claim 1, wherein the sample comprises B cells.

4. The method of claim 1, wherein the nucleic acid expression data is obtained by measuring the RNA level of the nucleic acid sequence.

5. The method of claim 1, wherein the nucleic acid expression data is derived from at least three nucleic acid sequences.

6. The method of claim 1, wherein the nucleic acid expression data is derived from at least four nucleic acid sequences.

7. The method of claim 6, wherein the nucleic acid sequences are selected from the group consisting of ESR1, MAPK3, MECP2, PSTPIP1, SLA, STK11, WNK1, and ZNF446.

8. The method of claim 1, wherein the subject is a post-menopausal female.

9. A method of diagnosing low bone mass density in a subject, the method comprising:
a. obtaining nucleic acid expression data from a plurality of nucleic acid sequences derived from a biological sample collected from the subject, wherein at least one nucleic acid sequence is selected from the group consisting of ESR1, MAPK3, MECP2, PSTPIP1, SLA, STK11, WNK1, and ZNF446;
b. comparing the nucleic acid expression data to a standard to determine the relative risk of low bone mass density in subject.

10. The method of claim 9, wherein the sample comprises blood.

11. The method of claim 9, wherein the sample comprises B cells.

12. The method of claim 9, wherein the nucleic acid expression data is obtained by measuring the RNA level of the nucleic acid sequence.

13. The method of claim 9, wherein the nucleic acid expression data is derived from at least three nucleic acid sequences.

14. The method of claim 9, wherein the nucleic acid expression data is derived from at least four nucleic acid sequences.

15. The method of claim 14, wherein the nucleic acid sequences are selected from the group consisting of ESR1, MAPK3, MECP2, PSTPIP1, SLA, STK11, WNK1, and ZNF446.

16. The method of claim 9, wherein the subject is a post-menopausal female.

17. A method for determining the relative level of risk for low bone mass density in a human subject, the method comprising:
a. obtaining nucleic acid expression data from a plurality of nucleic acid sequences derived from B-cells collected from the subject, wherein at least one nucleic acid sequence is selected from the group consisting of ESR1, MAPK3, MECP2, PSTPIP1, SLA, STK11, WNK1, and ZNF446;
b. comparing the nucleic acid expression data to a standard to determine the relative risk of low bone mass density in subject.

18. The method of claim 17, wherein the nucleic acid expression data is obtained by measuring the RNA level of the nucleic acid sequence.

19. The method of claim 17, wherein the nucleic acid expression data is derived from at least two nucleic acid sequences.

20. The method of claim 19, wherein the nucleic acid sequences are selected from the group consisting of ESR1, MAPK3, MECP2, PSTPIP1, SLA, STK11, WNK1, and ZNF446.
